(19) United States
(12) Patent Application Publication
(10) Pub. No.: US 2015/0288533 A1
(43) Pub. Date: Oct. 8, 2015

(54) METHOD AND DEVICE FOR REMOTE INTELLIGENT CONTROL

(71) Applicant: Xiaomi Inc., Beijing (CN)

(72) Inventors: Pengfei ZHANG, Beijing (CN); Yong CHEN, Beijing (CN); Yidong WANG, Beijing (CN); Hongwei GUO, Beijing (CN)

(73) Assignee: Xiaomi Inc.

(21) Appl. No.: 14/570,349

(22) Filed: Dec. 15, 2014

Related U.S. Application Data
(63) Continuation of application No. PCT/CN2014/084360, filed on Aug. 14, 2014.

(30) Foreign Application Priority Data
Apr. 8, 2014 (CN) 201410141371.1

(51) Int. Cl. H04L 12/28

(52) U.S. Cl. CPC H04L 12/2825; H04L 12/2818

(57) ABSTRACT

A method for remote intelligent control includes acquiring a trigger event, generating a notification message according to the trigger event, pushing the notification message to at least one notified terminal, receiving a control instruction returned by the at least one notified terminal, and controlling a controlled terminal corresponding to the control instruction according to the control instruction. The control instruction is generated according to the notification message.

### CROSS-REFERENCE TO RELATED APPLICATIONS

This application is a Continuation of International Application No. PCT/CN2014/084360, with an international filing date of Aug. 14, 2014, which is based upon and claims the benefit of priority to Chinese Patent Application No. 201410141371.1, filed on Apr. 8, 2014, the entire contents of both of which are incorporated herein by reference.

### TECHNICAL FIELD

The disclosure relates to intelligent control technology and, more particularly, to a method and device for remote intelligent control.

### BACKGROUND

Household appliances have become important electrical equipment in people's daily life. A traditional household appliance is controlled, for example, using buttons on the appliance or remotely using an infrared remote controller. Such control methods may not meet users' need nowadays.

Following this trend, a concept of smart home is developed. The so-called smart home refers to integrating appliances related to a household on a platform of a housing, by utilizing integrated wiring technology, network communication technology, security technology, automatic control technology, and audio and video technology, and building an efficient management system for residential facilities and household daily affairs, to improve safety, convenience, comfort, and artistry of the household life, and to achieve an eco-friendly living environment. This concept has been widely considered to be an important trend of future development in household appliances.

### SUMMARY

In accordance with the disclosure, there is provided a method for remote intelligent control. The method includes acquiring a trigger event, generating a notification message according to the trigger event, pushing the notification message to at least one notified terminal, receiving a control instruction returned by the at least one notified terminal, and controlling a controlled terminal corresponding to the control instruction according to the control instruction. The control instruction is generated according to the notification message.

Also in accordance with the disclosure, there is provided a method for remote intelligent control. The method includes receiving a notification message pushed from a controlling device, generating a control instruction according to the notification message for controlling a controlled terminal coupled to the controlling device, and returning the control instruction to the controlling device. The notification message is generated according to a trigger event acquired by the controlling device.

Also in accordance with the disclosure, there is provided a device for remote intelligent control. The device includes a processor and a non-transitory computer-readable memory storing instructions. The instructions, when executed by the processor, cause the processor to acquire a trigger event, generate a notification message according to the trigger event, push the notification message to at least one notified terminal, receive a control instruction returned by the at least one notified terminal, and control a controlled terminal corresponding to the control instruction according to the control instruction. The control instruction being generated according to the notification message.

Also in accordance with the disclosure, there is provided a device for remote intelligent control. The device includes a processor and a non-transitory computer-readable memory storing instructions. The instructions, when executed by the processor, cause the processor to receive a notification message pushed from a controlling device, generate a control instruction according to the notification message for controlling a controlled terminal coupled to the controlling device, and return the control instruction to the controlling device. The notification message is generated according to a trigger event acquired by the controlling device.

Also in accordance with the disclosure, there is provided a non-transitory computer-readable storage medium storing instructions. The instructions, when executed by one or more processors of a controlling device, causes the controlling device to acquire a trigger event, generate a notification message according to the trigger event, push the notification message to at least one notified terminal, receive a control instruction returned by the at least one notified terminal, and control a controlled terminal corresponding to the control instruction according to the control instruction. The control instruction is generated according to the notification message.

Also in accordance with the disclosure, there is provided a non-transitory computer-readable storage medium storing instructions. The instructions, when executed by one or more processors of a terminal, causes the terminal to receive a notification message pushed from a controlling device, generate a control instruction according to the notification message for controlling a controlled terminal coupled to the controlling device, and return the control instruction to the controlling device. The notification message is generated according to a trigger event acquired by the controlling device.

It should be understood that, the above general description and the detailed description below are merely exemplary and explanatory, and do not limit the disclosure.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart showing a method for remote intelligent control according to an exemplary embodiment.

FIG. 2A is a flow chart showing a method for acquiring a trigger event according to an exemplary embodiment.

FIG. 2B is a flow chart showing a method for acquiring a trigger event according to another exemplary embodiment.

FIG. 3 is a flow chart showing a method for generating a notification message according to an exemplary embodiment.

FIG. 4 is a flow chart showing a method for remote intelligent control according to an exemplary embodiment.

FIG. 5A is a flow chart showing a method for generating a control instruction according to an exemplary embodiment.

FIG. 5B is a flow chart showing a method for generating a control instruction according to another exemplary embodiment.

FIG. 6 is a block diagram showing a router for remote intelligent control according to an exemplary embodiment.

FIG. 7 is a block diagram showing a terminal for remote intelligent control according to an exemplary embodiment.

FIG. 8 is a schematic view showing an interface of a terminal for remote intelligent control according to an exemplary embodiment.

FIG. 9 is a block diagram showing a device for remote intelligent control according to an exemplary embodiment.

### DETAILED DESCRIPTION

Embodiments consistent with the disclosure include a method and device for remote intelligent control.

Hereinafter, embodiments consistent with the disclosure will be described with reference to the drawings. Wherever possible, the same reference numbers will be used throughout the drawings to refer to the same or like parts.

In the disclosure, unless otherwise specified, an electronic device may be a mobile phone, a tablet computer, an e-book reader, a Moving Picture Experts Group Audio Layer III (MP3) player, a Moving Picture Experts Group Audio Layer IV (MP4) player, a portable laptop computer or a desktop computer, and the like.

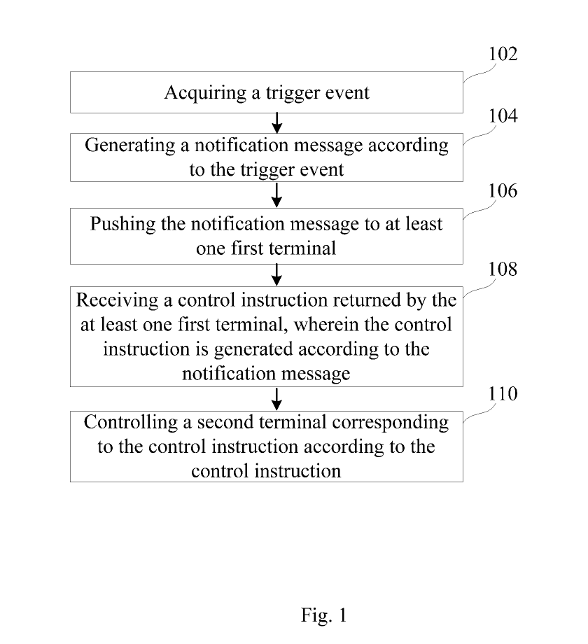

FIG. 1 is a flow chart showing an exemplary method for remote intelligent control consistent with embodiments of the disclosure. This method may be implemented, for example, by a router.

As shown in FIG. 1, at 102, a trigger event is acquired. At 104, a notification message is generated according to the trigger event. At 106, the notification message is pushed to at least one first terminal (hereinafter, a “first terminal” is also referred to as a “notified terminal”). At 108, a control instruction returned by the at least one first terminal is received, wherein the control instruction is generated according to the notification message. At 110, a second terminal (hereinafter, a “second terminal” is also referred to as a “controlled terminal”) corresponding to the control instruction is controlled according to the control instruction.

For example, in some embodiments, a router acquires a trigger event of a second terminal and generates a corresponding notification message according to the trigger event. Then, the router pushes the notification message to a first terminal at a remote location. A user can receive the notification message and return a corresponding control instruction based on the notification message using the first terminal The router then controls a corresponding second terminal according to the control instruction. As such, a function of remote intelligent control can be achieved by the user through the router. The method for remote intelligent control may enrich control manners on household appliances, and provide technical basis for achieving a smart home.

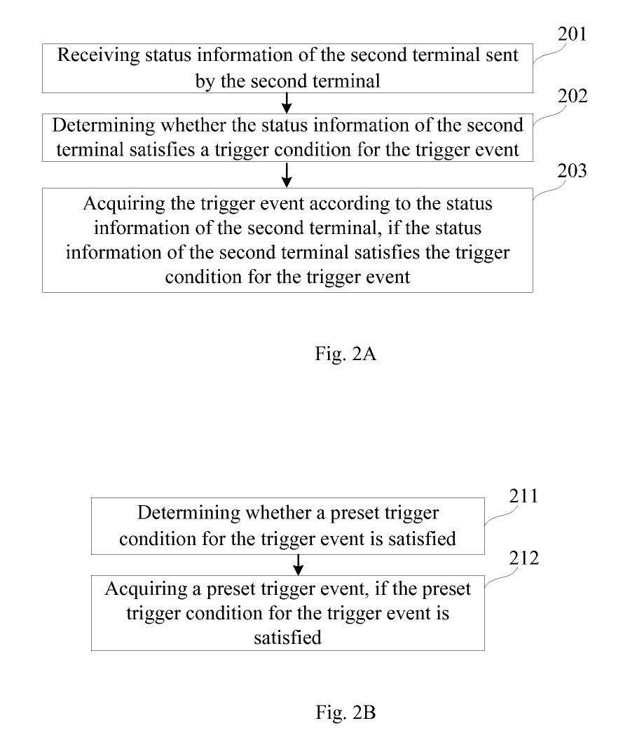

FIG. 2A is a flow chart showing an exemplary method for acquiring a trigger event consistent with embodiments of the disclosure. As shown in FIG. 2A, at 201, status information of the second terminal sent from the second terminal is received. The second terminal may be a household appliance in a same Local Area Network (LAN) environment with the router, such as an air conditioner, a television, a water heater, a camera, or a computer terminal, and the like. Generally, these terminal devices may automatically detect their own status and a condition of the environment. For example, an air conditioner may detect a temperature of a room space, a water heater may detect a current temperature of the water, and so on. Such a terminal device can send the detected relevant status information to the router through the LAN.

The second terminal may also be a server or another terminal coupled to the router through the Internet. For example, a user sets a TV series, Man From the Stars, as a following target. When a new episode of the TV series is updated on a server that provides video resources, information of the episode is sent to the router through the Internet.

At 202, it is determined whether the status information of the second terminal satisfies a trigger condition for the trigger event.

At 203, if the status information of the second terminal satisfies the trigger condition for the trigger event, the trigger event is acquired according to the status information of the second terminal

The trigger condition for the status information of the second terminal may be preset by the user. When the status information of the second terminal satisfies the relevant trigger condition, a trigger event is determined to have occurred. For example, the user sets water temperature lower than 50° C. as a trigger condition, and when the status information sent from the water heater indicates that the water temperature is lower than 50° , such an event, i.e., the water temperature being lower than 50° is determined to be a trigger event. Different trigger events are acquired according to respective status information sent from respective terminals.

FIG. 2B is a flow chart showing another exemplary method for acquiring a trigger event consistent with embodiments of the disclosure. As shown in FIG. 2B, at 211, it is determined whether a preset trigger condition for the trigger event is satisfied.

At 212, if the preset trigger condition for the trigger event is satisfied, a preset trigger event is acquired.

According to FIG. 2B, the trigger event may be triggered by a trigger condition preset by the user, in addition to being triggered by status information sent from the second terminal as shown in FIG. 2A. For example, the user sets, in the router, that a reminder message needs to be pushed on April 8, which is his wife's birthday. In this case, when the router detects that the current time satisfies the preset trigger condition preset by the user, the preset trigger event is acquired.

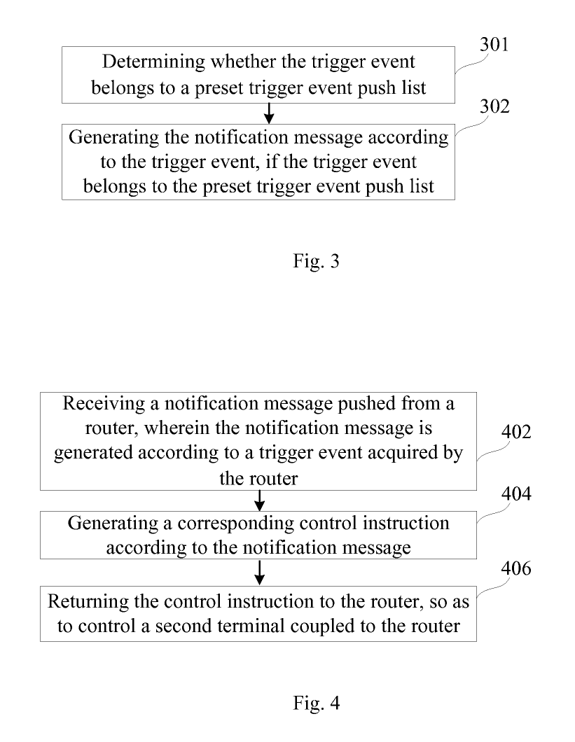

FIG. 3 is a flow chart showing an exemplary method for generating a notification message consistent with embodiments of the disclosure. As shown in FIG. 3, at 301, it is determined whether the trigger event belongs to a preset trigger event push list.

At 302, if the trigger event belongs to the preset trigger event push list, the notification message is generated according to the trigger event.

In some scenarios, the number of trigger events that may be acquired is large. However, in practice the user may only need to be notified of a few trigger events that he or she will use for a remote intelligent control. Therefore, the user can preset trigger events that he or she needs to be notified of in the trigger event push list. After the router acquires a trigger event, it determines whether the trigger event belongs to the preset trigger event push list. If the acquired trigger event belongs to the list, a notification message is generated.

Accordingly, the user is shielded from the trigger events that the user does not need to be notified of

The notification message may be pushed to at least one preset first terminal at a remote location.

In addition, notification messages may be pushed to different first terminals according to different trigger events. A correlation list recording the correlation between different types of notification messages and different first terminals may be preset in the router. The router classifies the notification messages according to trigger events, and a notification message is pushed to a corresponding first terminal according to the correlation list.

The notification message includes contents of a video, a picture, and/or a text that are acquired according to the trigger event.

FIG. 4 is a flow chart showing another exemplary method for remote intelligent control consistent with embodiments of the disclosure. This method may be implemented, for example, by a terminal.

As shown in FIG. 4, at 402, a notification message pushed from a router is received, wherein the notification message is generated according to a trigger event acquired by the router.

At 404, a corresponding control instruction is generated according to the notification message.

At 406, the control instruction is returned to the router, so as to control a second terminal coupled to the router.

For example, in some embodiments, a first terminal at a remote location receives a notification message pushed from a router and learns a trigger event acquired by the router. The first terminal generates a corresponding control instruction according to the notification and returns the control instruction to the router. A remote control on a second terminal, which sends the trigger event, is achieved through the router. As such, a function of remote intelligent control can be achieved by the user through the router. The method for remote intelligent control may enrich control manners on household appliances, and provide technical basis for achieving a smart home.

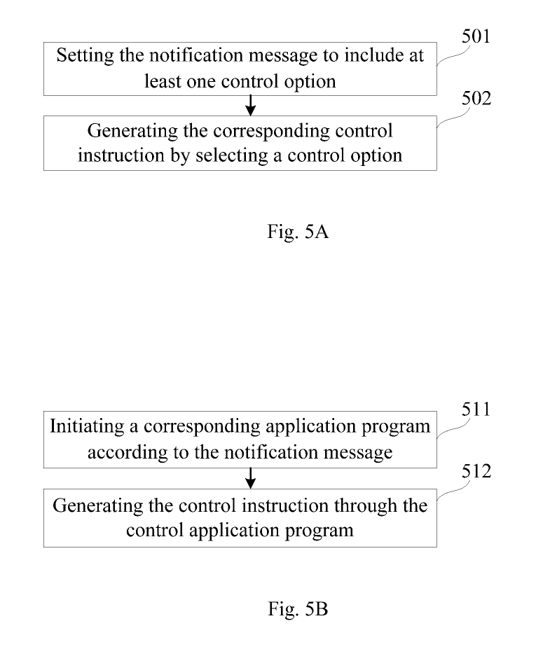

FIG. 5A is a flow chart showing an exemplary method for generating a control instruction consistent with embodiments of the disclosure. As shown in FIG. 5A, at 501, the notification message is set to include at least one control option. At 502, the corresponding control instruction is generated by selecting the control option. That is, the notification message generated by the router includes at least one preset control option. When the notification message is presented to the user, the at least one control option is also displayed. The user can select a control option after reading the notification message, and the corresponding control instruction can then be generated accordingly.

For example, a water heater detects status information showing that the temperature of the water in the water heater is lower than 50° C. The router acquires this trigger event and generates a notification message which includes two control options—“turn on the water heater” and “turn off the water heater.” When the notification message is presented to the user, two buttons respectively for the two control options—“turn on the water heater” and “turn off the water heater”—are displayed in the displayed notification message. The user can instruct to generate a control instruction by clicking on the button for the corresponding control option.

For another example, the router acquires a trigger event that a PM2.5 index is above a critical level through monitoring status information of the environment provided by an indoor environment monitor or a public environment index publishing platform, and generates a notification message. The notification message includes two control options—“turn on the air purifier” and “turn off the air purifier.” When the notification message is presented to the user, two buttons respectively for the two control options—“turn on the air purifier” and “turn off the air purifier”—are displayed in the displayed notification message. The user can instruct to generate a control instruction by clicking on the button for the corresponding control option.

FIG. 5B is a flow chart showing another exemplary method for generating a control instruction consistent with embodiments of the disclosure. As shown in FIG. 5B, at 511, a corresponding application program is initiated according to the notification message. At 512, the control instruction is generated by the control application program.

That is, control application programs are installed on the first terminal A corresponding control application program may be initiated according to the notification message. The user can use the control application program to generate a corresponding control instruction by setting a control parameter.

For example, an air conditioner detects status information that a room temperature is higher than 30 [symbol] ° C. The router acquires the trigger event, and generates a notification message that includes type information that indicates the notification message is a notification message about the air conditioner. A control application program for the air conditioner is installed on the first terminal When the user reads the notification message, he or she can click on the notification message. The first terminal then initiates the control application program according to the relevant type information in the notification message. The control application program provides settings for parameters of the air conditioner, such as “temperature,” “air volume,” “power mode,” and the like, so that the user can set these parameters using the control application program. Thereafter, the control application program for the air conditioner generates a corresponding control instruction according to the final control parameters set by the user.

In addition to the relevant control parameters, the control instruction may also include a video, a picture, and/or text content. The first terminal can acquire relevant contents through corresponding application programs, a detailed description of which is omitted here.

In summary, consistent with embodiments of the disclosure, a router acquires a trigger event of a second terminal and generates a corresponding notification message according to the trigger event. Then, the router pushes the notification message to a first terminal at a remote location. The first terminal at the remote location receives the notification message pushed from the router, and learns the trigger event acquired by the router. The first terminal generates a corresponding control instruction according to the notification message, and returns the control instruction to the router. A remote control of the second terminal that sends the trigger event is then achieved through the router. As such, a function of remote intelligent control may be achieved by the user through the router. The method for remote intelligent control may enrich control manners on household appliances, and provide technical basis for achieving a smart home.

Hereinafter, exemplary apparatuses configured to perform the methods consistent with embodiments of the disclosure will be described. The above description of methods consistent with the disclosure may be referred to for details about the apparatuses that are not described.

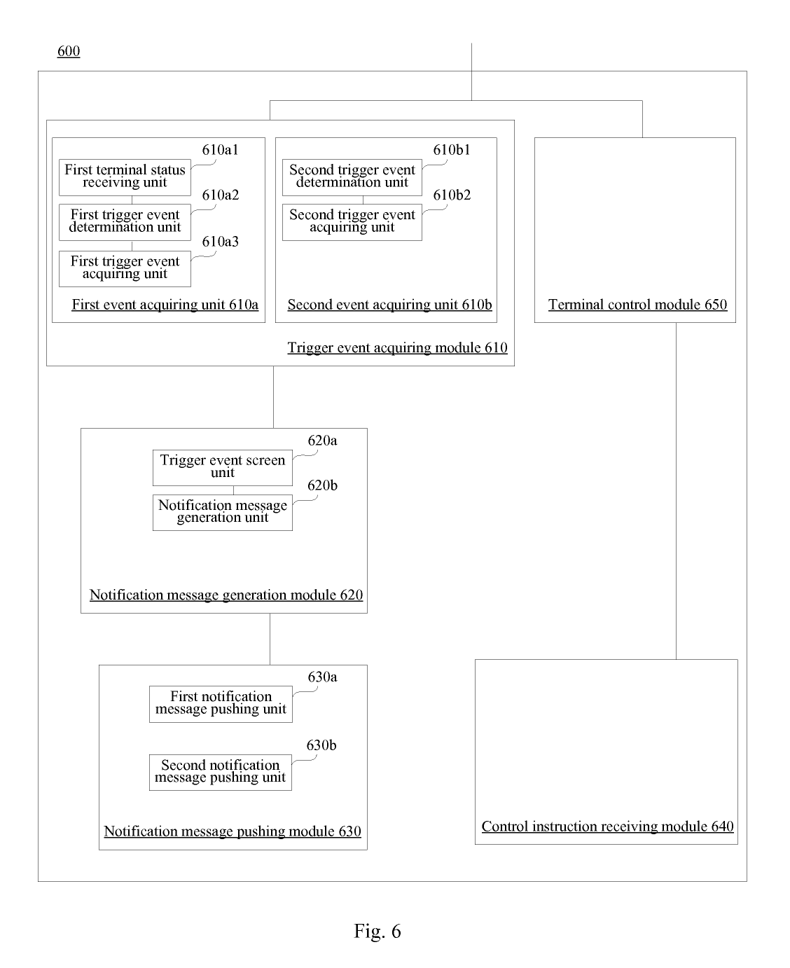

FIG. 6 is a block diagram showing an exemplary router 600 for remote intelligent control consistent with embodiments of the disclosure. The router 600 may be implemented with software, hardware, or a combination of both, as a part or whole of an electronic device. The router 600 includes a trigger event acquiring module 610, a notification message generation module 620, a notification message pushing module 630, a control instruction receiving module 640, and a terminal control module 650.

The trigger event acquiring module 610 is configured to acquire a trigger event. The notification message generation module 620 is configured to generate a notification message according to the trigger event. The notification message pushing module 630 is configured to push the notification message to at least one first terminal The control instruction receiving module 640 is configured to receive a control instruction returned by at least one first terminal, wherein the control instruction is generated according to the notification message. The terminal control module 650 is configured to control a second terminal corresponding to the control instruction according to the control instruction.

In some embodiments, the trigger event acquiring module 610 may include several units, such as a first event acquiring unit 610a and/or a second event acquiring unit 610b shown in FIG. 6.

The first event acquiring unit 610a includes a first terminal status receiving unit 610a1, configured to receive status information of the second terminal sent from the second terminal; a first trigger event determination unit 610a2, configured to determine whether the status information of the second terminal satisfies a trigger condition for the trigger event; and a first trigger event acquiring unit 610a3, configured to acquire the trigger event according to the status information of the second terminal, if the status information of the second terminal satisfies the trigger condition for the trigger event.

The second event acquiring unit 610b includes a second trigger event determination unit 610b1, configured to determine whether a preset trigger condition for the trigger event is satisfied; and a second trigger event acquiring unit 610b2, configured to acquire a preset trigger event, if the preset trigger condition for the trigger event is satisfied.

In some embodiments, the notification message generation module 620 includes a trigger event screen unit 620a, configured to determine whether the trigger event belongs to a preset trigger event push list; and a notification message generation unit 620b, configured to generate the notification message according to the trigger event, if the trigger event belongs to the preset trigger event push list.

In some embodiments, the notification message pushing module 630 includes a first notification message pushing unit 630a and/or a second notification message pushing unit 630b. The first notification message pushing unit 630a is configured to push the notification message to at least one preset first terminal The second notification message pushing unit 630b is configured to push the notification message to at least one first terminal corresponding to the trigger event according to the trigger event.

In some embodiments, the notification message includes a video, a picture, and/or text content that are acquired according to the trigger event.

In some embodiments, the router 600 and the second terminal are in the same LAN environment.

In summary, the router 600 for remote intelligent control acquires a trigger event of a second terminal and generates a corresponding notification message according to the trigger event. Then, the router 600 pushes the notification message to a first terminal at a remote location. A user can use the first terminal to receive the notification message and return a corresponding control instruction based on the notification message. The router 600 controls a corresponding second terminal according to the control instruction. As such, a function of remote intelligent control may be achieved by the user through the router 600. The router 600 for remote intelligent control may enrich control manners on household appliances, and provide technical basis for achieving a smart home.

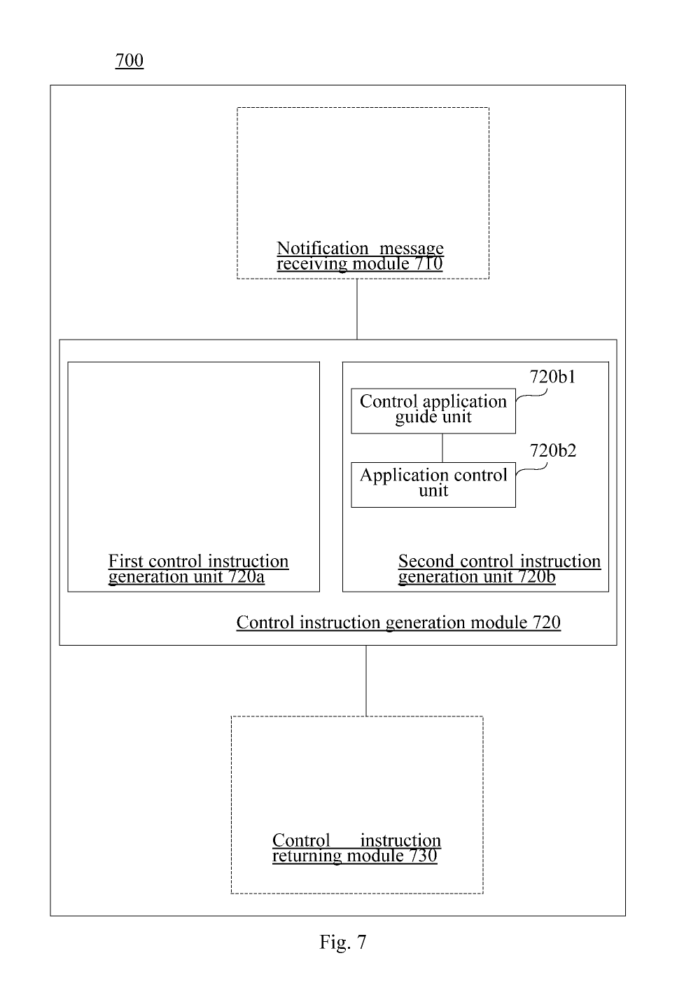

FIG. 7 is a block diagram showing an exemplary terminal 700 for remote intelligent control consistent with embodiments of the disclosure. The terminal 700 may be implemented with software, hardware, or a combination of both, as a part or whole of an electronic device. The terminal 700 includes a notification message receiving module 710, a control instruction generation module 720, and a control instruction returning module 730.

The notification message receiving module 710 is configured to receive a notification message pushed from a router. The notification message is generated according to a trigger event acquired by the router. The control instruction generation module 720 is configured to generate a corresponding control instruction according to the notification message. The control instruction returning module 730 is configured to return the control instruction to the router, so as to control a second terminal coupled to the router.

In some embodiments, the control instruction generation module 720 includes several units, such as a first control instruction generation unit 720a and/or a second control instruction generation unit 720b.

The first control instruction generation unit 720a is configured to generate the corresponding control instruction by selecting one of a plurality control options included in the notification message.

The second control instruction generation unit 720b includes a control application guide unit 720b1, configured to initiate a corresponding application program according to the notification message; and an application control unit 720b2, configured to generate the control instruction through the control application program.

In some embodiments, the control instruction includes a video, a picture, and/or text contents.

For the exemplary apparatuses described above, specific implementation of operations of the respective modules have been described in detail in the description of the exemplary methods, and is not repeated here.

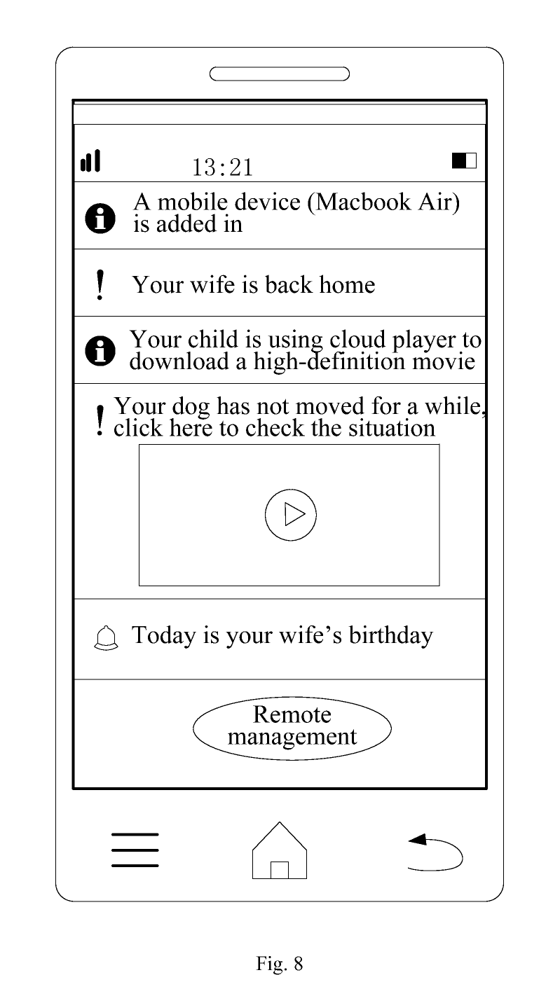

FIG. 8 is a schematic view showing an exemplary interface of an exemplary terminal for remote intelligent control consistent with embodiments of the disclosure. In this example, the terminal for remote intelligent control is a mobile terminal As shown in FIG. 8, the mobile terminal receives a notification message sent from a router, and displays it on its interface. For notification messages of different types, different icons are prompted on the interface. FIG. 8 shows, as an example, notification messages for three application scenarios, which are described below.

Scenario 1: Birthday Wish for Wife.

In this exemplary application scenario, the user preset a wife birthday reminder at the router for a need to push a notification message on his wife's birthday. When the router detects that the current time satisfies the trigger condition preset by the user, the router acquires a preset trigger event, and pushes the generated corresponding notification message to the user's mobile terminal After the user's mobile terminal receives the notification message, the user's mobile terminal prompts a notification “Today is your wife's birthday” on the interface, as shown in FIG. 8. After the user receives the prompted notification, he can initiate an application program for a camera on the mobile terminal, record a birthday wish video, and then add the video to a control instruction to be returned. The control instruction can be set to play the video when his wife arrives home. After the user sets up the control instruction, the user returns the control instruction to the router. The recorded video is sent to a storage space of the router or a cloud storage space coupled to the router.

When the user's wife arrives home, the router recognizes that by detecting information of a terminal device that is added into the family Wi-Fi. The router acquires the trigger event, generates a corresponding notification message, and the notification message is pushed to the user's mobile terminal After the user's mobile terminal receives the notification message, the user's mobile terminal displays the notification “Your wife is back home” on the interface, as shown in FIG. 8. After receiving the notification, the user clicks on the notification to generate a control instruction to play the video, and returns the control instruction to the router. After receiving the control instruction, the router turns on the smart television coupled to the router to play the previously recorded birthday wish video.

Scenario 2: Management of Children's Operations.

In this exemplary application scenario, the router receives a control signal sent by a certain terminal device, requesting to download a high-definition movie from a cloud player. The router recognizes that the operator of the terminal device is the user's child by detecting information of the terminal device. Then, the router determines that this trigger event satisfies a trigger condition, acquires the trigger event, generates a corresponding notification message, and pushes the notification message to the user's mobile terminal After receiving the notification message, the user's mobile terminal displays the notification “Your child is using cloud player to download a high-definition movie” on the interface, as shown in FIG. 8. After receiving the notification, the user can click on the notification to check relevant information of the movie being downloaded. If the user considers the movie being downloaded is not appropriate for a child to watch, the user can send a control instruction to the router, so as to control the router to cease downloading the movie.

Scenario 3: Real-Time Monitoring of Pets.

In this exemplary application scenario, a camera is installed in the home to monitor pets in real time. The camera is connected in a home LAN, and is coupled to the router. When the camera monitors that a pet has not moved for a preset length of time, the camera triggers a trigger event and sends the trigger event to the router. When receiving the trigger event, the router generates a corresponding notification message and pushes the notification message to the user's mobile terminal After receiving the notification message, the user's mobile terminal displays the alarm notification “Your dog has not moved for a while, click here to check the situation” on the interface, as shown in FIG. 8, accompanied with a warning sound to alert the user. Meanwhile, as shown in FIG. 8, a video stream interface is also provided in the alarm notification. The user can click on the video stream interface to establish a link for transferring video stream from the camera in the home, so as to achieve a real-time monitoring of pets at home.

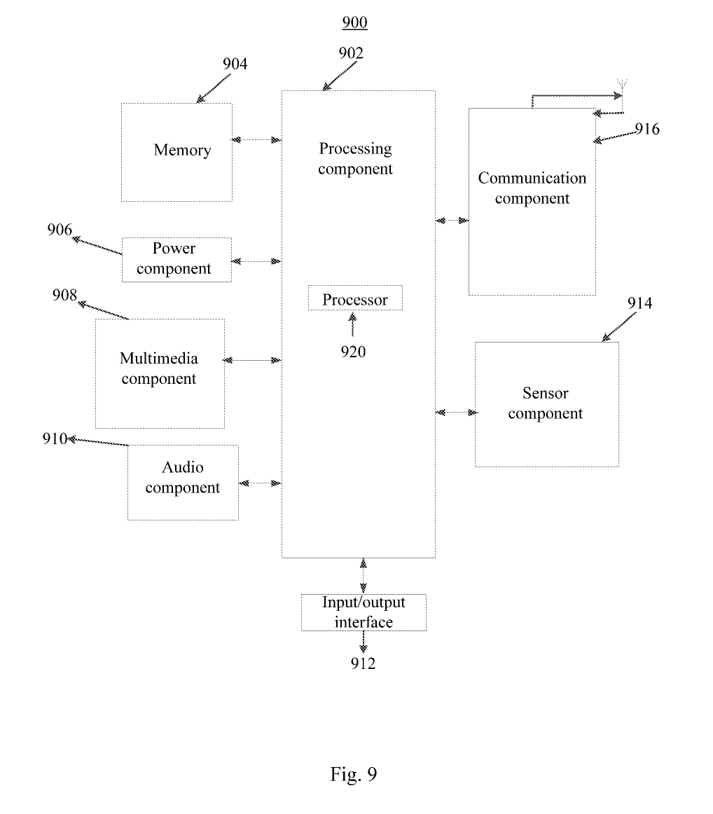

FIG. 9 is a block diagram showing an exemplary device 900 for remote intelligent control consistent with embodiments of the disclosure. For example, the device 900 may be a mobile phone, a computer, a digital broadcast terminal, a messaging device, a gaming console, a tablet, a medical device, exercise equipment, a personal digital assistant, and the like.

As shown in FIG. 9, the device 900 includes one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 includes one or more processors 920 to execute instructions to perform all or a part of the methods consistent with embodiments of the disclosure. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive external multimedia data while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the device 900 and other devices. The device 900 may access a wireless network based on a communication standard, such as Wi-Fi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium storing instructions that, when executed by a processor, cause the processor to perform a method consistent with embodiments of the disclosure. For example, the storage medium may be the memory 904, which stores instructions executable by the processor 920 in the device 900, for performing the above-described methods. The non-transitory computer-readable storage medium may be a ROM, a RAM, a CD-ROM, a magnetic tape, a floppy disc, an optical data storage device, and the like.

Those skilled in the art will recognize that part or all of the methods described above may be implemented with hardware, or programs instructing the related hardware. The programs may be stored in a computer readable storage medium. The storage medium described above may be a read-only memory, a magnetic disc, an optical disc or the like.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for remote intelligent control, comprising:
acquiring, by a processor of a controlling device, a trigger event;
generating, by the processor, a notification message according to the trigger event;
pushing, by the processor, the notification message to at least one notified terminal;
receiving, by the processor, a control instruction returned by the at least one notified terminal, the control instruction being generated according to the notification message; and
controlling, by the processor, a controlled terminal corresponding to the control instruction according to the control instruction.

2. The method of claim 1, wherein acquiring the trigger event includes:
receiving a status information of the notified terminal sent by the notified terminal;
determining whether the status information satisfies a trigger condition for the trigger event; and
acquiring the trigger event according to the status information if the status information satisfies the trigger condition.

3. The method of claim 1, wherein acquiring the trigger event includes:
determining whether a preset trigger condition for the trigger event is satisfied; and
acquiring the trigger event if the preset trigger condition is satisfied.

4. The method of claim 1, wherein generating the notification message includes:
determining whether the trigger event belongs to a preset trigger event push list; and
generating the notification message according to the trigger event if the trigger event belongs to the preset trigger event push list.

5. The method of claim 1, wherein pushing the notification message to the at least one notified terminal includes:
pushing the notification message to at least one preset notified terminal; or
pushing the notification message to at least one notified terminal corresponding to the trigger event according to the trigger event.

6. The method of claim 1, wherein generating the notification message includes generating a notification message containing at least one of a video, a picture, or text content acquired according to the trigger event.

7. The method of claim 1, wherein controlling the controlled terminal includes controlling a controlled terminal in a same local area network with the controlling device.

8. A method for remote intelligent control, comprising:
receiving, by a processor, a notification message pushed from a controlling device, the notification message being generated according to a trigger event acquired by the controlling device;
generating, by the processor, a control instruction according to the notification message for controlling a controlled terminal coupled to the controlling device; and
returning, by the processor, the control instruction to the controlling device.

9. The method of claim 8, wherein generating the control instruction includes:
receiving a selection of a control option included in the notification message; and
generating a control instruction according to the selected control option.

10. The method of claim 8, wherein generating the control instruction includes:
initiating an application program according to the notification message; and
generating a control instruction using the control application program.

11. A device for remote intelligent control, comprising:
a processor; and
a non-transitory computer-readable memory storing instructions that, when executed by the processor, cause the processor to:
acquire a trigger event;
generate a notification message according to the trigger event;
push the notification message to at least one notified terminal;
receive a control instruction returned by the at least one notified terminal, the control instruction being generated according to the notification message; and
control a controlled terminal corresponding to the control instruction according to the control instruction.

12. The device of claim 11, wherein the instructions further cause the processor to:
receive status information of the controlled terminal sent by the controlled terminal;
determine whether the status information satisfies a trigger condition for the trigger event; and
acquire the trigger event according to the status information if the status information satisfies the trigger condition .

13. The method of claim 11, wherein the instructions further cause the processor to:
determine whether a preset trigger condition for the trigger event is satisfied; and
acquire the trigger event if the preset trigger condition is satisfied.

14. The device of claim 11, wherein the instructions further cause the processor to:
determine whether the trigger event belongs to a preset trigger event push list; and
generate the notification message according to the trigger event if the trigger event belongs to the preset trigger event push list.

15. The device of claim 11, wherein the instructions further instruct the processor to:
push the notification message to at least one preset notified terminal; or
push the notification message to at least one notified terminal corresponding to the trigger event according to the trigger event.

16. A device for remote intelligent control, comprising:
a processor; and
a non-transitory computer-readable memory storing instructions that, when executed by the processor, cause the processor to:
receive a notification message pushed from a controlling device, the notification message being generated according to a trigger event acquired by the controlling device;
generate a control instruction according to the notification message for controlling a controlled terminal coupled to the controlling device; and
return the control instruction to the controlling device.

17. The device of claim 16, wherein the instructions further cause the processor to:
receive a selection of a control option included in the notification message; and
generate the control instruction according to the selected control option.

18. The device of claim 16, wherein the instructions further cause the processor to:
initiate an application program according to the notification message; and
generate the control instruction using the control application program.

19. A non-transitory computer-readable storage medium storing instructions that, when executed by one or more processors of a controlling device, causes the controlling device to:
acquire a trigger event;
generate a notification message according to the trigger event;
push the notification message to at least one notified terminal;
receive a control instruction returned by the at least one notified terminal, the control instruction being generated according to the notification message; and
control a controlled terminal corresponding to the control instruction according to the control instruction.

20. A non-transitory computer-readable storage medium storing instructions that, when executed by one or more processors of a terminal, causes the terminal to:
receive a notification message pushed from a controlling device, the notification message being generated according to a trigger event acquired by the controlling device;
generate a control instruction according to the notification message for controlling a controlled terminal coupled to the controlling device; and
return the control instruction to the controlling device.
